(19) United States
(12) Patent Application Publication
(10) Pub. No.: US 2005/0080983 A1
(43) Pub. Date: Apr. 14, 2005

(54) Method and apparatus for transmitting and storing data

(75) Inventor: In-Young Chung, Suwon-si (KR)

Correspondence Address: F. CHAU & ASSOCIATES, LLC, 130 WOODBURY ROAD, WOODBURY, NY, 11797, US

(73) Assignee: SAMSUNG ELECTRONICS CO., LTD.

(21) Appl. No.: 10/889,408

(22) Filed: Jul. 12, 2004

(30) Foreign Application Priority Data
Oct. 13, 2003 (KR) 2003-70986

(51) Int. Cl. G06F 12/00

(52) U.S. Cl. 711/100

(57) ABSTRACT

A method and an apparatus for reducing the number of mask bits in a memory system are disclosed. A memory controller transmits mask bits representing a mask pattern that is an address to a memory device in a masked write operation. The memory device generates the same mask pattern as that selected by the memory controller by decoding the received address, compares input data with the generated mask pattern by a bitwise comparison, and according to the comparison result, discards data having the same pattern as the selected mask pattern and writes the other data in a memory array. The number of bits of the address transmitted from the memory controller to the memory device is smaller than the number of bits of the mask pattern. The memory controller and the memory device use the method to reduce the number of the mask bits.

### CROSS REFERENCE TO RELATED APPLICATION

This application claims priority to Korean Patent Application No. 2003-70986, filed on Oct. 13, 2003, in the Korean Intellectual Property Office, the disclosure of which is incorporated herein in its entirety by reference.

### BACKGROUND

1. Technical Field

The present invention relates to a data storing method and a data storing apparatus, and more particularly, to a method and an apparatus for transmitting mask bits, which represent a mask pattern in a packet type memory system.

2. Discussion of the Related Art

In a packet type memory system, a masked write operation is performed to write only a portion of a data packet output from a memory controller to a memory device, and masked data is data in the data packet that are not written in the memory device.

FIG. 1 shows a block diagram of a conventional packet type memory system in a masked write operation. In FIG. 1, a memory system 10 includes a memory controller 12, a mask byte field 13, a data channel 14, an instruction channel 16, and a memory device 18. The memory device 18 is a yellowstone DRAM (YDRAM).

When a data write operation is performed in the packet type memory system 10, the memory controller 12 transmits a plurality of data to be written (Write Bytes A00 through B71) to the memory device 18 via the data channel 14 at the same time. These data are written and stored in a memory array (not shown) located in the memory device 18. The data that is not to be written and stored in the memory array (not shown) in the memory device 18 is discarded. In operation, the memory controller 12 compares each write byte of the data with each mask byte from the mask byte field 13 by a bitwise comparison, selects a mask byte that is different from every one of the write bytes and overwrites the write byte with the selected mask byte. The data overwritten by the selected mask byte is included in a write command packet and transmitted to the memory device 18 via the instruction channel 16. Hence, the data overwritten by the selected mask bytes is represented by mask bits.

The memory controller 12 includes a mask byte field 13 having a plurality of mask bytes (Mask Bytes 0 through 31). When the data write operation is performed, the memory controller 12 compares each data (Write Bytes A00 through B71) to be transmitted with each mask byte (Mask Bytes 0 through 31) of the mask byte field 13 by a bitwise comparison and selects one mask byte which is not the same as each data (Write Bytes A00 through B71) to be transmitted.

Each of the plurality of mask bytes (Mask Bytes 0 through 31) is made up of 8 bits, and there are 8 bits of data in each of Write Bytes A00 through B71.

For example, the memory controller 12 compares a first mask byte (Mask Byte 0) with the data to be transmitted (Write Bytes A00 through B71) by a bitwise comparison and generates a hit signal HIT when the mask byte (Mask Byte 0) is the same as at least one of the data to be transmitted (Write Bytes A00 through B71). Then, in response to the hit signal HIT, the memory controller 12 compares a second mask byte (Mask Byte 1) with the data to be transmitted (Write Bytes A00 through B7l) by a bitwise comparison. The memory controller 12 performs the comparing procedure as described above for succeeding mask bytes unless a hit signal HIT is not generated.

If a mask byte is not the same as every one of the data to be transmitted in Write Bytes A00 through B71 after the memory controller 12 compares the mask byte (For example, Mask Byte 6) with the data to be transmitted (Write Bytes A00 through B71) by a bitwise comparison, the mask byte (Mask Byte 6) is selected and a selection signal SEL is generated.

In response to the selection signal SEL, the memory controller 12 over-writes the selected mask byte (Mask Byte 6) on each data to be masked (For example, assuming Write Bytes B60, B70, A31, A41, and B71 are data not to be written in a memory device, thereby to be masked). Therefore, each of the data (Write Bytes B60, B70, A31, A41, and B71) is replaced with the mask byte (Mask Byte 6).

The memory controller 12 loads the selected mask byte (Mask Byte 6) in a write instruction packet and transmits the write instruction packet including 8 mask bits to the memory device 18 via the instruction channel 16.

### SUMMARY OF THE PREFERRED EMBODIMENTS

The embodiments of the present invention provide a method and an apparatus for reducing the number of mask bits in a packet type memory system.

According to one exemplary embodiment of the present invention, an apparatus comprises a memory controller, which transmits mask bits representing a mask pattern that is an address, to a memory device in a masked write operation; and the memory device, which generates the same mask pattern as that selected and transmitted by the memory controller by decoding the received address, compares input data with the generated mask pattern by a bitwise comparison, and according to the comparison result, discards the data to be masked and writes the other data in a memory array, wherein the number of bits of an address transmitted from the memory controller to the memory device is smaller than the number of bits of the mask pattern, and the memory controller and the memory device perform a method of reducing the number of the mask bits.

According to another exemplary embodiment of the present invention, a method for outputting data from a memory controller comprises: comparing each of a plurality of data patterns With each of a plurality of mask patterns and selecting one mask pattern which is not the same as every one of the plurality of data patterns from the plurality of mask patterns; substituting at least one data pattern to be masked from among the plurality of data with the selected mask pattern; and outputting an address representing the selected mask pattern, wherein the number of bits of the address is smaller than the number of bits of the selected mask pattern.

According to yet another exemplary embodiment of the present invention, a method for storing data in a memory device comprises: receiving an address; selecting one mask pattern from a plurality of mask patterns based on the address; receiving data; and comparing the selected mask pattern with the received data and storing every received data pattern, which is not the same as the selected mask pattern, into the memory device, wherein the number of bits of the selected mask pattern is larger than the number of bits of the address.

According to still another exemplary embodiment of the present invention, a method for outputting data from a memory controller comprises: comparing each of a plurality of data patterns with each of a plurality of mask patterns and selecting one mask pattern which is not the same as every one of the plurality of data patterns from the plurality of mask patterns; substituting at least one data to be masked from among the plurality of data with the selected mask pattern; and outputting the address made up of a portion of bits of the selected mask pattern.

According to still another exemplary embodiment of the present invention, a method for storing data into a memory device comprises: receiving an address made up of bits of a first group; generating a mask pattern by combining bits of a second group with the bits of a first group; receiving data; and comparing the generated mask pattern with the received data and storing the received data pattern into the memory device when the received data pattern is not the same as the generated mask pattern.

According to still another exemplary embodiment of the present invention, a method for storing data output from a memory controller in a memory device comprises: wherein in the memory controller, comparing each of a plurality of data patterns with each of a plurality of mask patterns; selecting one mask pattern which is not the same as every one of the plurality of data patterns from the plurality of mask patterns; substituting at least one data to be masked from among the plurality of data with the selected mask pattern; and outputting the address representing the selected mask pattern; wherein in the memory device, receiving the address output from the memory controller; selecting one mask pattern from a plurality of mask patterns stored in the memory device based on the received address; receiving a plurality of data output from the memory controller; and, comparing the selected mask pattern with the received data patterns and storing every received data pattern, which is not the same as the selected mask pattern, wherein the number of bits of the selected mask pattern is larger than the number of bits of the address.

According to another exemplary embodiment of the present invention, a memory controller for outputting data from a memory controller, the memory controller compares each of a plurality of data patterns with each of a plurality of mask patterns, selects a mask pattern, which is not the same as every one of the plurality of data patterns, from the plurality of mask patterns, substitutes at least one data to be masked from among the plurality of data with the selected mask pattern, and outputs the address representing the selected mask pattern, wherein the number of bits of the address is smaller than the number of bits of the selected mask pattern.

According to yet another exemplary embodiment of the present invention, a memory device comprises: a memory array; a first port which receives data; a second port which receives an address to select a mask pattern; a mask pattern field in which stores a plurality of mask patterns; and a comparison circuit which selects one mask pattern from the plurality of mask patterns based on the address, compares the selected mask pattern with received data patterns, and outputs every received data, which is not the same as the selected mask pattern, to the memory array, wherein the number of bits of the selected mask pattern is larger than the number of bits of the address.

According to still another exemplary embodiment of the present invention, a memory system comprises: a memory controller which has a plurality of mask patterns and outputs at least one data to be masked and an address representing one mask pattern selected from the plurality of mask patterns; a memory device which has the plurality of mask patterns; a data channel which connects the memory device to the memory controller and carries the data from the memory controller to the memory device; and an instruction channel which connects the memory device to the memory controller and carries the address from the memory controller to the memory device, and the memory device further comprises: a memory array; and a comparison circuit which selects one mask pattern from the plurality of mask patterns based on the address received via the instruction channel, compares the selected mask pattern with the patterns of the data received via the data channel, and outputs every received data, which is not the same as the selected mask pattern, to the memory array, wherein the number of bits of the selected mask pattern is larger than the number of bits of the address.

According to yet another exemplary embodiment of the present invention, a memory system comprises: a memory controller which has a plurality of mask patterns and outputs at least one data to be masked and an address, which is made up of bits of a first group of bits of one mask pattern selected from the plurality of mask patterns; a memory device which has bits of a second group; a data channel which connects the memory device to the memory controller and carries the data from the memory controller to the memory device; and an instruction channel which connects the memory device to the memory controller and carries the address from the memory controller to the memory device, and the memory device further including: a memory array; and a comparison circuit which generates the same mask pattern as that selected by the memory controller by combining the bits of the second group with the address received via the instruction channel, compares the generated mask pattern with the patterns of the data received via the data channel, and outputs every received data, which is not the same as the generated mask pattern, to the memory array, wherein the number of bits of the selected mask pattern is larger than the number of bits of the address.

These and other exemplary embodiments and features of the present invention will be described and become apparent from the following detailed description of exemplary embodiments thereof, which is to be read in connection with the accompanying drawings.

### BRIEF DESCRIPTION OF THE DRAWINGS

The features of the embodiments of the present invention will be described in further detail and will become more apparent from the detailed description of the exemplary embodiments thereof, with reference to the attached drawings in which:

FIG. 1 is a block diagram of a memory system performing a conventional masked write operation;

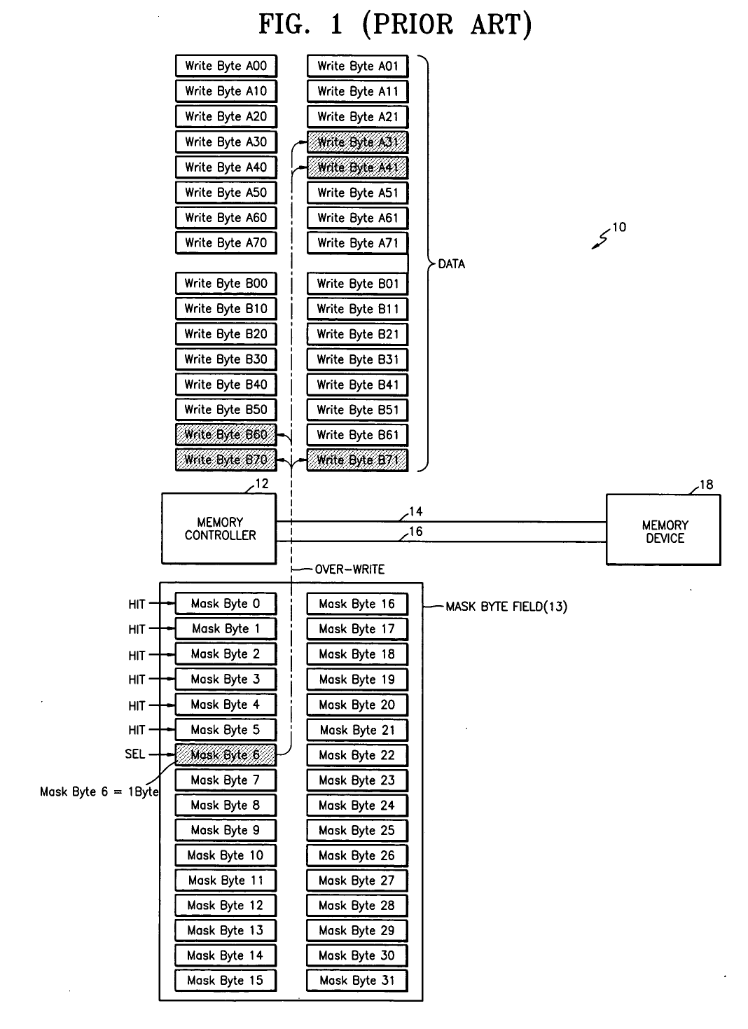

FIG. 2 is a block diagram of a memory system performing a masked write operation according to an exemplary embodiment of the present invention;

FIG. 3 is a flowchart of the masked write operation performed in the memory system shown in FIG. 2;

FIG. 4 is a block diagram of a memory system performing a masked write operation according to another exemplary embodiment of the present invention; and

FIG. 5 is a flowchart of the masked write operation performed in the memory system shown in FIG. 4.

### DETAILED DESCRIPTION OF THE PREFERRED EMBODIMENTS

Hereinafter, exemplary embodiments of the present invention will be described more fully with reference to the accompanying drawings.

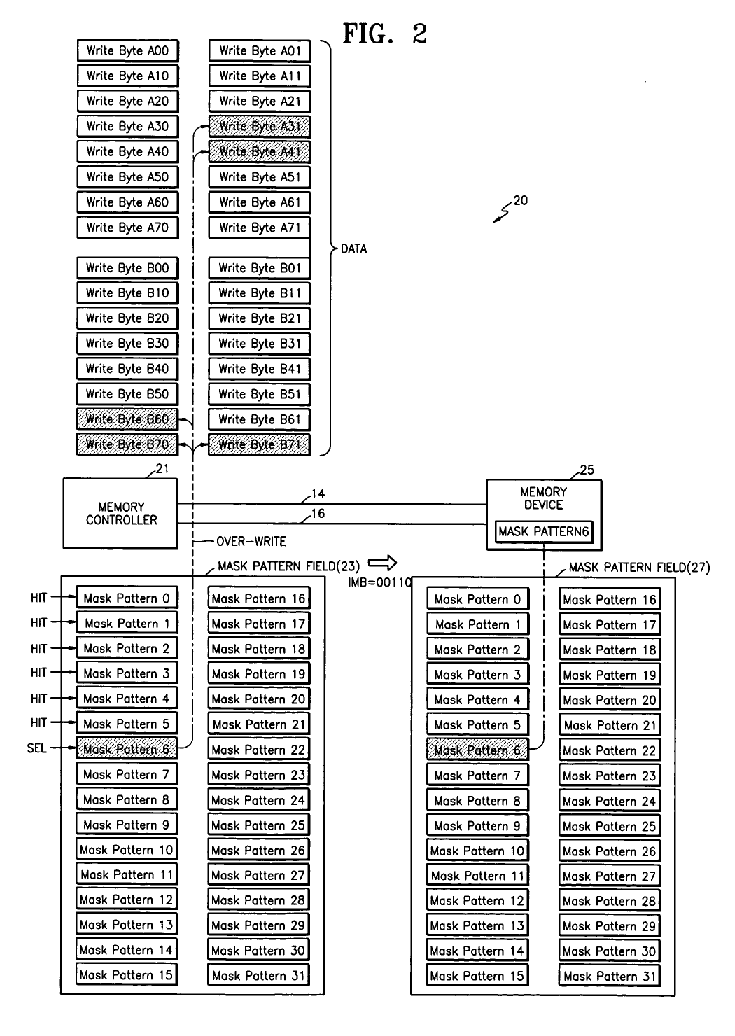

FIG. 2 is a block diagram of a memory system performing a masked write operation according to an exemplary embodiment of the present invention.

Referring to FIG. 2, a memory system 20 includes a memory controller 21 and a memory device 25. A data packet (or data) output from the memory controller 21 is transmitted to the memory device 25 via a data channel 14, and a command packet including mask bits is transmitted to the memory device 25 via an instruction channel 16.

Each port of the memory controller 21 and the memory device 25 connected to the data channel 14 is a first port, and each port of the memory controller 21 and the memory device 25 connected to the instruction channel 16 is a second port. The data channel 14 and the instruction channel 16 are buses. In one preferred exemplary embodiment, the memory device 25 is an YDRAM.

The memory controller 21 and the memory device 25 have the same mask pattern fields 23 and 27, respectively. A plurality of mask patterns (Mask patterns 0 through 31) included in the mask pattern fields 23 and 27 are the same, respectively. Also, the plurality of mask patterns (Mask patterns 0 through 31) can be uniquely addressed using M bits (M is a natural number), respectively.

For purpose of illustration, every 2_{M}(for example, M=5, 2^{M}=32) data of Write Bytes A00 through B71 is an 8-bit data and every 2^{M} (for example, M=5, 2^{M}=32) mask pattern (Mask patterns 0 through 31) is also an 8-bit mask pattern. Also, in one exemplary embodiment, the number of mask patterns is the same as or smaller than the number of data to be transmitted. However, the present invention is not limited to the above number of data packets (or data), the number of mask patterns, and the number of bits of the data and the mask patterns.

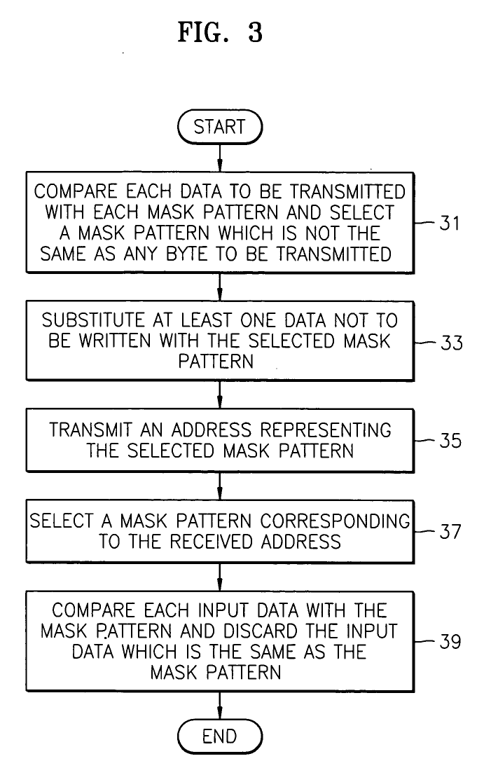

FIG. 3 is a flowchart illustrating a method for performing a masked write operation in a memory system according to one embodiment of the invention. For purpose of illustration, the exemplary method of FIG. 3 may be discussed with reference to the exemplary system of FIG. 2. Further, FIGS. 2 and 3 describe a case where the memory controller 21 does not store (or write) each of the data (For example, assuming Write Bytes B60, B70, A31, A41, and B71 are data not to be written in the memory device 25, thereby to be masked) in the memory device 25.

As shown in the flow chart of FIG. 3, in step 31, the memory controller 21 compares each data to be transmitted (Write Bytes A00 through B71) with each mask pattern (Mask patterns 0 through 31) of the mask pattern field 23 by a bitwise comparison and selects a mask pattern which is not the same as every one of the data to be transmitted (Write Bytes A00 through B71).

For example, the memory controller 21 compares a first mask pattern (Mask Pattern 0) with each data pattern to be transmitted (Write Patterns A00 through B71) by a bitwise comparison and generates a hit signal HIT when the mask pattern (e.g., Mask Pattern 0) is the same as at least one of data to be transmitted in Write Bytes A00 through B71. Then, in response to the hit signal HIT, the memory controller 21 compares a second mask pattern (Mask Pattern 1) with each data to be transmitted in Write Bytes A00 through B71 by a bitwise comparison. If another HIT is generated, the memory controller 21 moves to the next mask pattern (mask pattern 2) and repeats the comparing procedure described above unless the hit signal HIT is not generated.

If a mask pattern (e.g., Mask Pattern 6) is not the same as every one of the patterns of the data to be transmitted (Write Bytes A00 through B71) after the memory controller 21 compares the mask pattern (Mask Pattern 6) with each data pattern to be transmitted (Write Bytes A00 through B71) by a bitwise comparison, that mask pattern (Mask Pattern 6) is selected and a selection signal SEL is generated.

In response to the selection signal SEL, the memory controller 21 over-writes the selected mask pattern (Mask Pattern 6) on each of the data that are not to be written in the memory device (For example, assuming Write Bytes B60, B70, A31, A41, and B71 are not to be written in the memory device). Therefore, the data, Write Bytes B60, B70, A31, A41, and B71 are substituted with the Mask Pattern 6. That is, in step 33, the memory controller 21 overwrites at least one data to be masked with the selected mask pattern (Mask Pattern 6).

In step 35, the memory controller 21 transmits a mask bits address included in a write command packet (hereinafter, address or IMB) representing the selected mask pattern (e.g., Mask Pattern 6) to the memory device 25 via the instruction channel 16. For example, the selected mask pattern (Mask Pattern 6) is addressed as 00110.

That is, the memory controller 21 transmits an IMB, which is an address included in a write command packet to represent a selected mask pattern, instead of the selected mask pattern itself. For example, if the mask pattern is made up of one byte (=8 bits), the memory controller 21 can transmit an IMB, which is made up of M(M=5) bits, representing one selected mask pattern among 2^{M} (for example, M=5, 2^{M}=32) mask patterns.

In step 37, the memory device 25 receives the write command packet, detects the IMB included in the write command packet, and selects the mask pattern (Mask Pattern 6) from the mask pattern field 27 based on the received IMB. For example, the address 00110 indicates the mask pattern (Mask Pattern 6) made up of 8 bits.

That is, the memory device 25 performs a masked write operation using the same mask pattern as that selected by the memory controller 21.

In step 39, the memory device 25 receives each data (Write Bytes A00 through B71) input via the data channel 14 and compares the data (Write Bytes A00 through B71) with the mask pattern (Mask Pattern 6) by a bitwise comparison. If any of the patterns of the data (Write Bytes A00 through B71) is the same as the mask pattern (Mask Pattern 6), since the data having the same pattern as the mask pattern is a data not to be written in the memory device 25, the memory device 25 discards the data having the same pattern as the mask pattern.

For example, if every masked data of Write Bytes B60, B70, A31, A41, and B71 and the Mask Pattern 6 is the same, the memory device 25 does not store these data (Write Bytes B60, B70, A31, A41, and B71) in a memory array (not shown). A comparison circuit comparing each of the data (Write Bytes A00 through B71) with the mask pattern (Mask Pattern 6) by a bitwise comparison can be embodied by an XOR (Exclusive OR) logic circuit.

The comparison circuit of the memory device 25 selects one mask pattern (e.g., Mask Pattern 6) from a plurality of mask patterns comprising the mask pattern field 27 based on the address (IMB=00110) received via the instruction channel 16, compares the selected mask pattern (Mask Pattern 6) with the data (Write Bytes A00 through B71) received via the data channel 14, and outputs every received data, which is not the same as the selected mask pattern (Mask Pattern 6), to the memory array.

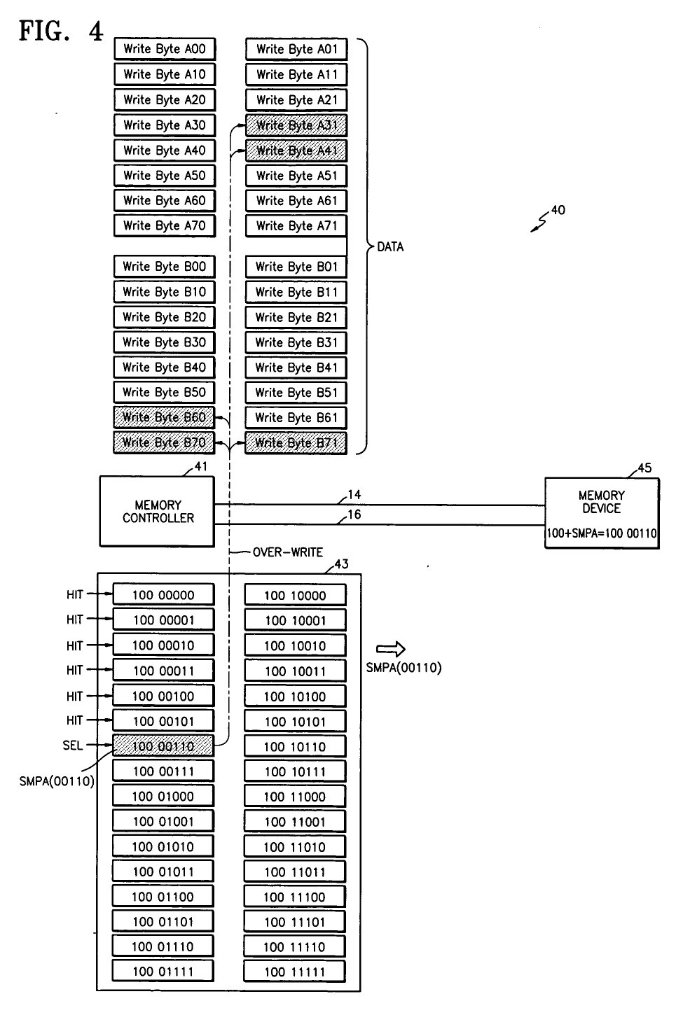

FIG. 4 is a block diagram of a memory system performing a masked write operation according to another exemplary embodiment of the present invention. As shown in FIG. 4, a memory system 40 includes a memory controller 41 and a memory device 45. The memory controller 41 and the memory device 45 are connected through the data channel 14 and the instruction channel 16.

The memory controller 41 includes a mask pattern field 43. If the memory controller 41 intends to transmit 2^{M} bits of (for example, M=5, 2^{M}=32) data, the mask pattern field 43 prepares 2^{M} (for example, M=5, 2_{M}=32) mask patterns.

For example, if each of the 32 mask patterns is made up of 8 bits, each of the 32 mask patterns can be independently set respectively, using only 5 bits (for example, the first 5 bits or the first group of 5 bits) of the 8 bits. Therefore, the optional 3 bits (for example, the second group of 3 bits) of the 8 bits can be used as a default by the memory controller 41 and the memory device 45.

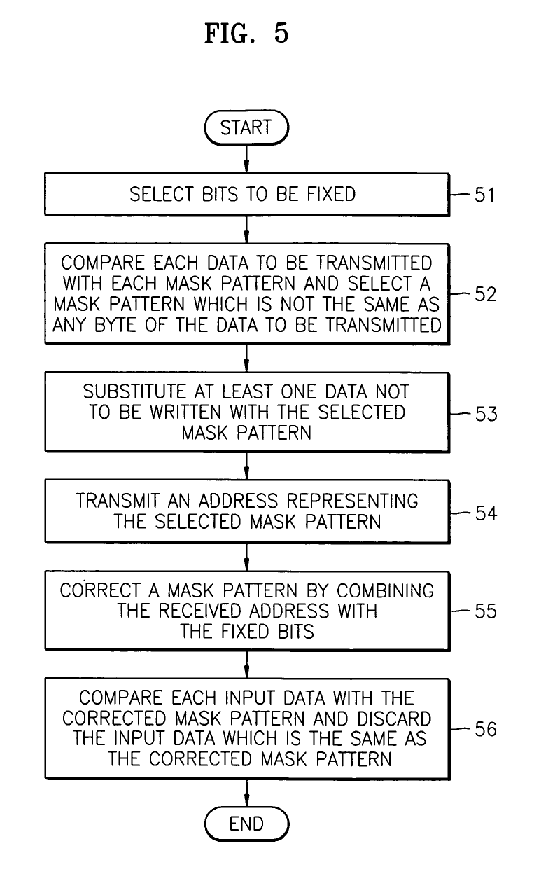

FIG. 5 is a flowchart illustrating a method for performing a masked write operation in a memory system according to another embodiment of the invention. For purpose of illustration, the exemplary method of FIG. 5 may be discussed with reference to the exemplary system of FIG. 4. Further, FIGS. 4 and 5 show a method for performing a masked write operation in the memory controller 41 and the memory device 45 using each of the masked data (e.g., Write Bytes B60, B70, A31, A41, and B71) according to this embodiment.

In step 51, a user or a manufacturer of a memory system selects the bits of a second group (for example, upper 3 bits including an MSB (Most Significant Bit)=100). Therefore, the bits of the second group are stored in the memory controller 41 and the memory device 45, respectively.

In step 52. the memory controller 41 compares each data to be transmitted (e.g., Write Bytes A00 through B71) with each mask pattern (e.g., 10000000 through 10011111) of the mask pattern field 43 by a bitwise comparison and selects a mask pattern, which is not the same as every one of the data to be transmitted in Write Bytes A00 through B71.

For example, the memory controller 41 compares a first mask pattern (100 00000) with each data to be transmitted (Write Patterns A00 through B71) by a bitwise comparison and generates a hit signal HIT when the mask pattern (100 00000) is the same as at least one of the data to be transmitted (Write Bytes A00 through B71). Then, in response to the hit signal HIT, the memory controller 41 compares a second mask pattern (100 00001) with each data to be transmitted (Write Bytes A00 through B71) by a bitwise comparison. The memory controller 41 performs the comparing procedure as described above for succeeding mask Bytes unless a hit signal HIT is not generated.

If a mask pattern (100 00110) is not the same as every one of the data to be transmitted (Write Bytes A00 through B71) after the memory controller 41 compares the mask pattern (100 00110) with each data to be transmitted (Write Bytes A00 through B71) by a bitwise comparison, the mask pattern (100 00110) is selected and a selection signal SEL is generated.

In response to the selection signal SEL, the memory controller 41 over-writes the selected mask pattern (100 00110) on each of the data to be masked (For example, assuming Write Bytes B60, B70, A31, A41, and B71 are data not to be written in the memory device, thereby to be masked). Therefore, every data to be masked (e.g., Write Bytes B60, B70, A31, A41, and B71) is substituted with the mask pattern (100 00110). That is, in step 53, the memory controller 41 substitutes at least one datum to be masked with the selected mask pattern (100 00110).

In step 54, the memory controller 41 transmits an address that is a selected mask pattern address (SMPA), which is made up of only the 5 bits of the first group (00110) excluding the 3 bits of the second group (100) of the selected mask pattern (100 00110), to the memory device 45 via the instruction channel 16 by loading in the write command packet.

The address (SMPA32 00110) is a mask pattern excluding the fixed bits of the second group (100) of the selected mask pattern (100 00110) and an address representing the selected mask pattern, simultaneously.

That is, the memory controller 41 transmits the address (SMPA32 00110) representing the selected mask pattern not the selected mask pattern (100 00110) itself. For example, if the mask pattern is made up of one byte, i.e., 8 bits, the memory controller 41 can transmit the address (SMPA=00110), which is made up of M (M=5) bits, representing one selected mask pattern (100 00110) among 2^{M} (M=5, 2^{M}=32) mask patterns.

In step 55, the memory device 45 receives the address (SMPA32 00110) representing the selected mask pattern (100 00110), combines the received address (SMPA32 00110) with the fixed bits of the second group (100) according to the predefined order, and generates the same mask pattern (100 00110) as that selected by the memory controller 41.

In step 56, the memory device 45 receives each data (Write Bytes A00 through B71) input via the data channel 14, compares each data (Write Bytes A00 through B71) with the mask pattern (100 00110) by a bitwise comparison, and discards the data to be masked from the data in Write Bytes A00 through B71 and writes and stores the rest of the data in the memory array.

For example, since every masked data (e.g., Write Bytes B60, B70, A31, A41, and B71) and the mask pattern (100 00110) are the same, the memory device 45 does not store the data (e.g., Write Bytes B60, B70, A31, A41, and B71). A comparison circuit compares each of the data (Write Bytes A00 through B71) with the mask pattern (100 00110) by a bitwise comparison can be embodied by an XOR logic circuit.

Since the method and apparatus for reducing the number of mask bits in a packet type memory system according to the embodiments of the present invention reduce the mask bits in a masked write operation, the width of the instruction channel is also reduced. Further, the number of bonding pads connected to the instruction channel is reduced as well.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for outputting data from a memory controller to a memory device, comprising:
comparing each of a plurality of data patterns with each of a plurality of mask patterns and selecting one mask pattern which is not the same as every one of the plurality of data patterns from the plurality of mask patterns;
substituting at least one data pattern to be masked from among the plurality of data patterns with the selected mask pattern; and
outputting an address representing the selected mask pattern,
wherein the number of bits of the address is smaller than the number of bits of the selected mask pattern.

2. The method of claim 1, wherein the address representing the selected mask pattern is included in a command packet.

3. The method of claim 1, further comprising:
outputting the plurality of data to the memory device.

4. The method of claim 1, wherein the plurality of mask patterns comprises 2^{M} mask patterns;
the output address is made up of M bits, representing the selected mask pattern; and
each of the 2^{M} mask patterns is made up of N bits, N and M are natural numbers, and N is larger than M.

5. The method of claim 1, wherein, the output address is made up of a portion of bits of the selected mask pattern.

6. A method for storing data in a memory device, comprising:
receiving an address;
selecting one mask pattern from a plurality of mask patterns based on the address;
receiving data; and
comparing the selected mask pattern with the received data and storing every received data having a pattern that is not the same as the selected mask pattern into the memory device,
wherein the number of bits of the selected mask pattern is larger than the number of bits of the address.

7. A method for storing data in a memory device, comprising:
receiving a command packet comprising an address, which is made up of M bits;
selecting one mask pattern from 2^{M} mask patterns based on the address;
receiving data; and
comparing the selected mask pattern with the received data and storing every received data pattern, which is not the same as the selected mask pattern, into the memory device.

8. The method of claim 7, wherein each of the 2^{M} mask patterns are made up of N bits, N and M are natural numbers, and N is larger than M.

9. A method for storing data into a memory device, comprising:
receiving an address made up of bits of a first group;
generating a mask pattern by combining bits of a second group with the bits of the first group;
receiving data; and
comparing the generated mask pattern with the received data and storing a received data pattern into the memory device when the received data pattern is not the same as the generated mask pattern.

10. The method of claim 9, wherein number of the first group of bits is selected according to the number of bits that is required to identify each of the generated mask patterns; and the number of the second group of bits is selected according to the number of bits that does not affect the identification of the number of generated mask patterns.

11. A method for storing data output from a memory controller in a memory device, comprising:
comparing each of a plurality of data with each of a plurality of mask patterns, selecting one mask pattern which is not the same as every one of the plurality of data from the plurality of mask patterns, substituting at least one data to be masked from among the plurality of data with the selected mask pattern, and outputting an address representing the selected mask pattern in the memory controller;
receiving the address output from the memory controller;
selecting one mask pattern from a plurality of mask patterns stored in the memory device based on, the received address in the memory device;
receiving a plurality of data output from the memory controller in the memory device; and
comparing the selected mask pattern with the received data and storing every received data having a pattern that is not the same as the selected mask pattern in the memory device,
wherein the number of bits of the selected mask pattern is larger than the number of bits of the address.

12. A memory controller for outputting data to a memory device, wherein
the memory controller compares a plurality of data with a plurality of mask patterns, selects a mask pattern, which is not the same as every one of the plurality of data, from the plurality of mask patterns, substitutes at least one data to be masked from among the plurality of data with the selected mask pattern, and outputs an address representing the selected mask pattern,
wherein the number of bits of the address is smaller than the number of bits of the selected mask pattern.

13. The memory controller of claim 12, wherein the memory controller outputs the plurality of data respectively, which comprise data substituted with the mask pattern, to the memory device.

14. A memory controller for transmitting data in a memory device, comprising:
a first port;
a second port;
a mask pattern field having 2^{M} mask patterns; and
wherein the memory controller compares each of a plurality of data with each of the 2^{M} mask patterns, selects a mask pattern which is not the same as every one of the plurality of data from the 2^{M} mask patterns, substitutes at least one data pattern to be masked from among the plurality of data with the selected mask pattern, outputs an address, which is made up of M bits, representing the selected mask pattern via the second port, and outputs the plurality of data comprising at least one data having a pattern substituted with the selected mask pattern via the first port,
wherein each of the 2^{M} mask patterns is made up of N bits, N and M are natural numbers, and N is larger than M.

15. A memory device comprising:
a memory array;
a first port which receives data;
a second port which receives an address to select a mask pattern;
a mask pattern field in which stores a plurality of mask patterns; and
a comparison circuit which selects one mask pattern from the plurality of mask patterns based on the address, compares the selected mask pattern with received data, and outputs every received data having a pattern that is not the same as the selected mask pattern to the memory array,
wherein the number of bits of the selected mask pattern is larger than the number of bits of the address.

16. A memory system comprising:
a memory controller which has a plurality of mask patterns and outputs at least one data to be masked and an address representing one mask pattern selected from the plurality of mask patterns;
a memory device which has the plurality of mask patterns;
a data channel which connects the memory device to the memory controller and carries the data from the memory controller to the memory device; and
an instruction channel which connects the memory device to the memory controller and carries the address from the memory controller to the memory device, and
wherein the memory device, further including:
a memory array; and
a comparison circuit which selects one mask pattern from the plurality of mask patterns based on the address received via the instruction channel, compares the selected mask pattern with data received via the data channel, and outputs every received data having a pattern that is not the same as the selected mask pattern to the memory array,
wherein the number of bits of the selected mask pattern is larger than the number of bits of the address.

17. The memory system of claim 16, wherein:
the address output from the memory controller is made up of a first group of bits of a mask pattern selected from the plurality of mask patterns; and
the memory device has bits of a second group,
wherein the comparison circuit generates the same mask pattern as that selected by the memory controller by combining the bits of the second group with the address received via the instruction channel, compares the generated mask pattern with the data received via the data channel, and outputs every received data having a pattern that is not the same as the generated mask pattern to the memory array.
